(19) United States
(12) Patent Application Publication
(10) Pub. No.: US 2023/0332318 A1
(43) Pub. Date: Oct. 19, 2023

(54) CIRCULAR ELECTROCHEMICAL METAL RECOVERY

(71) Applicant: Coby Tao, Fountain Hills, AZ (US)

(72) Inventor: Coby Tao, Fountain Hills, AZ (US)

(21) Appl. No.: 17/721,230

(22) Filed: Apr. 14, 2022

(51) Int. Cl. C25C 1/14; C22B 3/10; C22B 15/00; C25C 1/12; C25C 1/20; C22B 11/00; C22B 3/00

(52) U.S. Cl. CPC C25C 1/12; C22B 3/10; C22B 11/046; C22B 15/0071; C22B 25/04; C25C 1/14; C25C 1/20

(57) ABSTRACT

A method for recovering metals from scrap sources. The method includes obtaining scrap sources that include the metal to be recovered. The method also includes removing the metal from the scrap sources. Removing the metal from the scrap sources includes adding a reagent to the scrap sources, the reagent configured to leach the metal from the scrap sources creating a leachate. Removing the metal from the scrap sources also includes extracting the metal from the leachate and regenerating the reagent.

### CROSS-REFERENCE TO RELATED APPLICATIONS

Not applicable.

### BACKGROUND OF THE INVENTION

Hydrometallurgy is widely investigated for recovery of metals from solar energy wastes such as solar panels and other electronic wastes. It employs chemical solutions (typically acids) for selective or broad-spectrum leaching of metals from solar energy wastes and other electronic wastes. The metals in the leachate are then selectively or collectively extracted by solvent extraction and/or precipitation as metal salts. Hydrometallurgy can recover most of the metals in solar energy wastes and other electronic wastes with high purity. It is a low-temperature process with low energy consumption. It emits no carbon dioxide (CO₂) or carbon monoxide (CO).

Let us examine metal recovery from silicon solar panels by hydrometallurgy as an example. There are four metals in silicon solar cells which are worth recovery: silver, lead, tin, and copper. The most common acid to leach these four metals is nitric acid (HNO₃). Tin precipitates out of the leachate as tin oxide (SnO₂), so the nitric leachate contains three metals: silver, lead, and copper. One metal recovery example used a combination of solvent extraction, precipitation, and electrowinning to recover pure metals. They added a solvent, 2-hydroxy-5-nonylacetophenone oxime, to extract copper from the leachate. They then added sulfuric acid (H₂SO₄) to the solvent and formed copper sulfate (CuSO₄). In the CuSO₄ solution they performed electrowinning to recover copper. For the remaining leachate, they added hydrochloric acid (HCl to precipitate silver chloride (AgCl). They reacted AgCl with sodium hydroxide (NaOH) to obtain silver oxide (Ag₂O), which was then reduced to metallic silver by hydrazine (N₂H₄). To obtain high-purity silver of 99.99%, they used an electrorefining process with the recovered silver as the anode and an aqueous silver nitrate (AgNO₃) solution as the electrolyte. For lead recovery, they added NaOH to precipitate lead hydroxide (Pb(OH)₂). Then Pb(OH)₂ was heated to obtain lead oxide (PbO). Finally, sodium sulfide (Na₂S) was added to the leachate to remove the remaining lead by precipitation of lead sulfide (PbS).

As can be seen from the example above, traditional hydrometallurgical recycling has major disadvantages:
It requires many steps and many chemicals;
It consumes large amounts of chemicals and thus generates large amounts of chemical waste after single use of the chemicals;
It emits hazardous exhaust (hydrogen) during acid leaching; and
Further processing is needed to obtain pure metals from the recovered metal salts.

Accordingly, there is a need in the art for a recovery process that does not emit hydrogen during metal leaching. Further, there is a need in the art for a metal recovery process that produces pure metals rather than metallic salts. Finally, there is a need in the art for a metallic recovery process that minimizes the number and amount of chemicals required.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for recovering metals from scrap sources. The method includes obtaining scrap sources that include the metal to be recovered. The method also includes removing the metal from the scrap sources. Removing the metal from the scrap sources includes adding a reagent to the scrap sources, the reagent configured to leach the metal from the scrap sources creating a leachate. Removing the metal from the scrap sources also includes extracting the metal from the leachate and regenerating the reagent.

Another example embodiment includes a method for recovering metals from scrap sources. The method includes obtaining scrap sources that contain copper, tin, silver, and lead. The method also includes removing the copper from the scrap sources. Removing the copper from the scrap sources includes adding a first reagent to the scrap sources, the first reagent configured to leach copper from the scrap sources creating a first leachate and removing the first leachate from the scrap sources. Removing the copper from the scrap sources also includes extracting the copper from the first leachate and regenerating the first reagent. The method further includes removing the tin from the scrap sources. Removing the tin from the scrap sources includes adding a second reagent to the scrap sources, the second reagent configured to leach tin from the scrap sources creating a second leachate and removing the second leachate from the scrap sources. Removing the tin from the scrap sources also includes extracting the tin from the second leachate and regenerating the second reagent. The method additionally includes removing the silver from the scrap sources. Removing the silver from the scrap sources includes adding a third reagent to the scrap sources, the third reagent configured to leach silver from the scrap sources creating a third leachate and removing the third leachate from the scrap sources. Removing the silver from the scrap sources also includes extracting the silver from the third leachate and regenerating the third reagent. The method moreover includes removing the lead from the scrap sources. Removing the lead from the scrap sources includes adding a fourth reagent to the scrap sources, the fourth reagent configured to leach lead from the scrap sources creating a fourth leachate and extracting the lead from the fourth leachate.

Another example embodiment includes a method for recovering metals from scrap sources. The method includes obtaining scrap sources that contain copper, tin, silver, and lead. The method also includes removing the copper from the scrap sources. Removing the copper from the scrap sources includes submerging the scrap sources in an aqueous solution of sulfuric acid and adding hydrogen peroxide to the aqueous solution of sulfuric acid to create a copper leachate. Removing the copper from the scrap sources also includes removing the copper leachate from the scrap sources and extracting the copper from the copper leachate using electrowinning. Electrowinning plates the copper on a first cathode and regenerates the sulfuric acid. Removing the copper from the scrap sources further includes removing the first cathode including the plated copper from the sulfuric acid solution. The method further includes removing the tin from the scrap sources. Removing the tin from the scrap sources includes submerging the scrap sources in an aqueous solution of hydrochloric acid and adding hydrogen peroxide to the aqueous solution of hydrochloric acid to create a tin leachate. Removing the tin from the scrap sources also includes removing the tin leachate from the scrap sources and extracting the tin from the tin leachate using electrowinning. Electrowinning plates the tin on a second cathode and regenerates the hydrochloric acid. Removing the tin from the scrap sources further includes removing the second cathode including the plated tin from the hydrochloric acid solution. The method additionally includes removing the silver from the scrap sources. Removing the silver from the scrap sources includes submerging the scrap sources in an aqueous solution of hydrofluoric acid and adding hydrogen peroxide to the aqueous solution of hydrofluoric acid to create a silver leachate. Removing the silver from the scrap sources also includes removing the silver leachate from the scrap sources and extracting the silver from the silver leachate using electrowinning. Electrowinning plates the silver on a third cathode and regenerates the hydrofluoric acid. Removing the silver from the scarp sources also includes removing the third cathode including the plated silver from the hydrofluoric acid solution. The method moreover includes removing the lead from the scrap sources. Removing the lead from the scrap sources includes submerging the scrap sources in an aqueous solution of acetic acid and adding hydrogen peroxide to the aqueous solution of acetic acid to create a lead leachate. Removing the lead from the scrap sources also includes removing the lead leachate from the scrap sources and extracting the lead from the lead leachate using electrowinning. Electrowinning plates the lead on a fourth cathode. Removing the lead from the scrap sources further includes removing the fourth cathode including the plated lead from the acetic acid solution.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of circular electrochemical metal recovery;

FIG. 2 is a flowchart illustrating a method of recovering scrap copper from scrap sources that include copper;

FIG. 3 illustrates a method of extracting copper from a leachate;

FIG. 4 is a flowchart illustrating a method of recovering scrap tin from scrap sources that include tin;

FIG. 5 illustrates a method of extracting tin from a leachate;

FIG. 6 is a flowchart illustrating a method of recovering scrap silver from scrap sources that include silver;

FIG. 7 illustrates a method of extracting silver from a leachate;

FIG. 8 is a flowchart illustrating a method of recovering scrap lead from scrap sources that include lead;

FIG. 9 illustrates a method of extracting lead from a leachate;

FIG. 10 illustrates an example of an electrowinning system.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

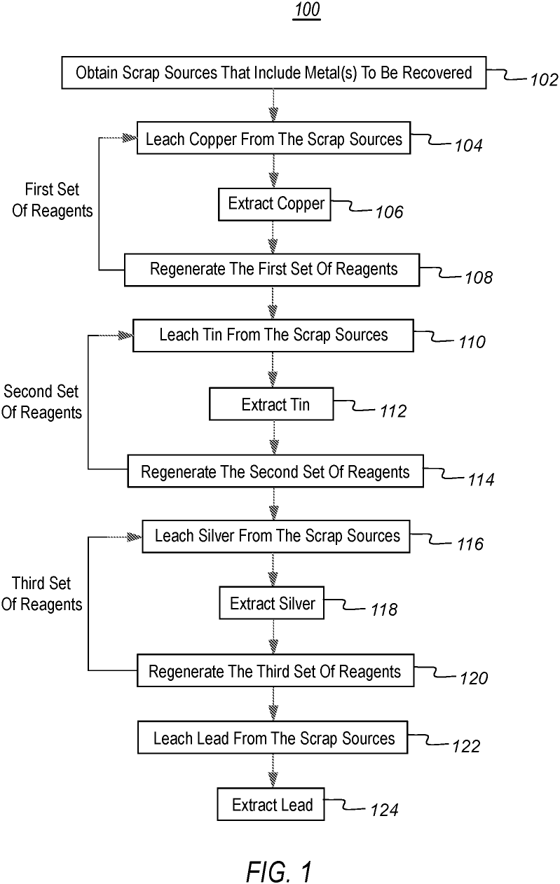

FIG. 1 is a flowchart illustrating a method 100 of circular electrochemical metal recovery. The method 100 not only allows for the recovery of metals, but at least some of the reagents used in the recovery process are regenerated, which prevents the process from producing large amounts of chemical waste. In fact, for some steps of the process, the only waste products are water and/or oxygen, which don’t produce any environmental dangers.

This method 100 is a circular process to recover metals from leachates of solar energy wastes such as solar panels and other electronic wastes, such as silver-coated copper electrical connectors, contacts, and wires. One of skill in the art will appreciate that while solar panels are used as exemplary herein, the process is applicable to other electronic wastes - thus when solar panels are mentioned herein, all other electronic wastes can be substituted. Some of these metals are extremely valuable, are environmentally dangerous to mine, and/or are toxic when thrown in a landfill. For example, the metals to be recovered can include silver, lead, tin, and copper.

This Invention is about a new hydrometallurgical process to recover metals from solar energy wastes including solar panels which maintains the advantages while eliminating most of the disadvantages of hydrometallurgy:
It significantly reduces the steps and chemicals (both in number and quantity) used for recycling;
It significantly reduces the amounts of chemical waste from recycling;
It eliminates hazardous exhaust (hydrogen) from acid leaching;
It recovers pure metals (pure silver, lead, tin, and copper), not metal salts; and
It enables a high metal recovery rate in excess of 99%.

The method 100 is chosen such that the conditions for electrowinning can be so chosen that the acid for silver leaching is regenerated and then reused for silver leaching. This regeneration and reuse can be repeated many times to reduce the chemical waste from the recycling process. The concept of circular chemistry is extended to recovery of other metals from solar energy wastes including tin and copper, i.e., the method 100 solves a major problem, closing the loops for solar energy wastes and other electronic wastes, without creating a new problem, large amounts of chemical waste whose proper treatments can be costly, polluting, and unsustainable.

Furthermore, the hazardous exhaust from metal leaching is eliminated with a benign and sustainable catalyst. Acid leaching of metals often generates hydrogen gas (H₂), which is explosive when mixed with oxygen (O₂). Special equipment for exhaust collection and treatment is required to properly handle the hydrogen exhaust, which often involves heating a mixture of hydrogen and air over 800° C. to convert hydrogen into water (H₂O). With the method 100 there is no hydrogen exhaust.

By way of example, lead is a highly poisonous metal (whether inhaled or swallowed), affecting almost every organ and system in the human body. At airborne levels of 100 mg/m³, it is immediately dangerous to life and health. Most ingested lead is absorbed into the bloodstream. The primary cause of its toxicity is its predilection for interfering with the proper functioning of enzymes. It does so by binding to the sulfhydryl groups found on many enzymes or mimicking and displacing other metals which act as cofactors in many enzymatic reactions. Among the essential metals that lead interacts with are calcium, iron, and zinc. When placed in a landfill, lead can leach into groundwater or be released into the air via burning of trash (whether intentional or unintentional).

The extraction, production, use, and disposal of lead and its products have caused significant contamination of the Earth’s soils and waters. Elevated concentrations of lead persist in soils and sediments in post-industrial and urban areas. Lead can accumulate in soils, especially those with a high organic content, where it remains for hundreds to thousands of years. Environmental lead can compete with other metals found in and on plants surfaces potentially inhibiting photosynthesis and at high enough concentrations, negatively affecting plant growth and survival. Contamination of soils and plants can allow lead to ascend the food chain affecting microorganisms and animals.

Children, in particular, are susceptible to adverse effects of environmental lead. Lead has no confirmed biological role but its prevalence in the human body-at an adult average of 120 mg[u]-is nevertheless exceeded only by zinc (2500 mg) and iron (4000 mg) among the heavy metals. Lead salts are very efficiently absorbed by the body. A small amount of lead (~1%) is stored in bones; the rest is excreted in urine and feces within a few weeks of exposure. However, only about a third of lead is excreted by a child. Continual exposure may result in the bioaccumulation of lead.

As of 2014, production of lead is increasing worldwide. There are two major categories of production: primary from mined ores, and secondary from scrap. In 2014, 4.58 million metric tons came from primary production (mined ores). According to the International Resource Panel’s Metal Stocks in Society report of 2010, the total amount of lead in use, stockpiled, discarded, or dissipated into the environment, on a global basis, is 8 kg per capita. Most lead ores contain a low percentage of lead (rich ores have a typical content of 3-8%) which must be concentrated for extraction. Thus, the amount of waste production is extremely high.

However, lead is easily recycled. There are well know process to recover lead from salts and metallic lead can be melted and alloys created at relatively low temperatures. The melting point of lead is 600.61 K (327.46° C., 621.43° F.). That is a low enough temperature that it can be melted over a wood fire under the right conditions. This makes working with molten lead relatively cheap and easy when compared to other heavy metals.

Any recovery of lead prevents that lead from entering landfills, ground water, soil or being introduced to the air through burning. It also reduces the need to mine lead ore and subsequently prevents environmental damage due to the mining process. The recovered lead can then be placed in the production cycle easily and seamlessly Therefore, any process which can recover lead from waste products prevents a large amount of environmental harm. This benefit is similar for other metals such as copper, tin, and silver.

FIG. 1 shows that the method 100 can include obtaining 102 scrap sources that include metal(s) to be recovered. Any scrap source that includes silver can be used. For example, scrap source can include silicon solar cells, silicon solar panels, electronic wastes, etc. The scrap source can be preprocessed to first recover other materials and/or can be processed after the method 100 is complete to recover other materials. That is, the method 100 is able to work on scrap sources that have already been processed or will later be processed, since this process targets metal extraction and most of the other materials remain unchanged. Thus, a user can determine where the method 100 fits in the overall procedure if other processing is to be done.

FIG. 1 also shows that the method 100 can include copper leaching 104 from the scrap sources. Copper leaching 104 is accomplished by adding the scrap sources to a reagent (or vice versa) to produce a leachate, from which the copper is extracted. The reagents that are used are typically quite corrosive. This is required because they have to be oxidative enough that they oxidize the copper so that it becomes soluble.

FIG. 1 further shows that the method 100 can include copper extraction 106. One method of extracting 106 the copper can include electrowinning, which removes metallic copper, rather than a copper salt, which must be further processed. However, any method which extracts the copper 106 from the leachate is acceptable and contemplated herein. The only requirement for copper extraction 106 is that it preserves the used reagents, so that the next step in the process can be accomplished.

FIG. 1 additionally shows that the method 100 can include regeneration 108 of the first set of reagents. That is, the reagents that were used in copper leaching 104 are regenerated, allowing them to be used once again to leach 104 copper, either from the same scrap sources or other scrap sources. This prevents the need to dispose of the used reagents, which is a hazardous material, and a circular process is created.

One of skill in the art will appreciate that the steps of copper extraction 106 and regeneration 108 of the copper leaching reagents can be a single step. For example, use of a reagent in copper leaching 104 oxidizes copper (removes electrons from the metallic copper - the electron is donated to the protons (H⁺) in the solution, allowing the formation of H₂O, along with the “extra” oxygen from the hydrogen peroxide, rather than the production of hydrogen gas), causing the copper to be soluble. Electrowinning the solution then reduces the copper (adds electrons to the dissolved copper turning it back to pure metallic copper that is easily recovered - since it is no longer mixed with other scrap materials) and oxidizes water, creating free protons which regenerate the reagent, as described below.

FIG. 1 moreover shows that the method 100 can include tin leaching 110 from the scrap sources. Tin leaching 110 is accomplished by adding the scrap sources to a second reagent (or vice versa) to produce a leachate, from which the tin is extracted. The second reagents that are used are typically quite corrosive. This is required because they must be oxidative enough that they oxidize the tin so that it becomes soluble. Some reagents can be used to leach more than one metal, which is not ideal (because then the recovered metal is impure) so the sequence is selected to provide leachates of only a single metal.

FIG. 1 also shows that the method 100 can include tin extraction 112. One method of extracting 112 the tin can include electrowinning, which removes metallic tin, rather than a tin salt, which must be further processed. However, any method which extracts 112 the tin from the leachate is acceptable and contemplated herein. The only requirement for tin extraction 112 is that it preserves the used reagents, so that the next step in the process can be accomplished.

FIG. 1 further shows that the method 100 can include regeneration 114 of the second set of reagents. That is, the reagents that were used in tin leaching 110 are regenerated, allowing them to be used once again to leach 110 tin, either from the same scrap sources or other scrap sources. This prevents the need to dispose of the used reagents, which is a hazardous material, and a circular process is created.

One of skill in the art will appreciate that the steps of tin extraction 112 and regeneration 114 of the tin leaching reagents can be a single step. For example, use of a reagent in tin leaching 110 oxidizes tin (removes electrons from the metallic tin -the electron is donated to the protons (H⁺) in the solution, allowing the formation of H₂O, along with the “extra” oxygen from the hydrogen peroxide, rather than the production of hydrogen gas), causing the tin to be soluble. Electrowinning the solution then reduces the tin (adds electrons to the dissolved tin turning it back to pure metallic tin that is easily recovered - since it is no longer mixed with other scrap materials) and oxidizes water, creating free protons which regenerate the reagent, as described below.

FIG. 1 additionally shows that the method 100 can include silver leaching 116 from the scrap sources. Silver leaching 116 is accomplished by adding the scrap sources to a third reagent (or vice versa) to produce a leachate, from which the silver is extracted. The third reagents that are used are typically quite corrosive. This is required because they must be oxidative enough that they oxidize the silver so that it becomes soluble. Some reagents can be used to leach more than one metal, which is not ideal (because then the recovered metal is impure) so the sequence is selected to provide leachates of only a single metal.

FIG. 1 moreover shows that the method 100 can include silver extraction 118. One method of extracting 118 the silver can include electrowinning, which removes metallic silver, rather than a silver salt, which must be further processed. However, any method which extracts 118 the silver from the leachate is acceptable and contemplated herein. The only requirement for silver extraction 118 is that it preserves the used reagents, so that the next step in the process can be accomplished.

FIG. 1 also shows that the method 100 can include regeneration 120 of the third set of reagents. That is, the reagents that were used in silver leaching 116 are regenerated, allowing them to be used once again to leach 116 silver, either from the same scrap sources or other scrap sources. This prevents the need to dispose of the used reagents, which is a hazardous material, and a circular process is created.

One of skill in the art will appreciate that the steps of silver extraction 118 and regeneration 120 of the silver leaching reagents can be a single step. For example, use of a reagent in silver leaching 116 oxidizes silver (removes electrons from the metallic silver- the electron is donated to the protons (H⁺) in the solution, allowing the formation of H₂O, along with the “extra” oxygen from the hydrogen peroxide, rather than the production of hydrogen gas), causing the silver to be soluble. Electrowinning the solution then reduces the silver (adds electrons to the dissolved silver turning it back to pure metallic silver that is easily recovered - since it is no longer mixed with other scrap materials) and oxidizes water, creating free protons which regenerate the reagent, as described below.

FIG. 1 further shows that the method 100 can include lead leaching 122 from the scrap sources. Lead leaching 122 is accomplished by adding the scrap sources to a fourth reagent (or vice versa) to produce a leachate, from which the lead is extracted. The third reagents that are used are typically quite corrosive. This is required because they must be oxidative enough that they oxidize the lead so that it becomes soluble. Some reagents can be used to leach more than one metal, which is not ideal (because then the recovered metal is impure) so the sequence is selected to provide leachates of only a single metal. When lead is leached 122 the reagents used are less stable than water and regeneration isn’t possible.

FIG. 1 additionally shows that the method 100 can include lead extraction 124. One method of extracting 124 the lead can include electrowinning, which removes metallic lead, rather than a lead salt, which must be further processed. However, any method which extracts 124 the lead from the leachate is acceptable and contemplated herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

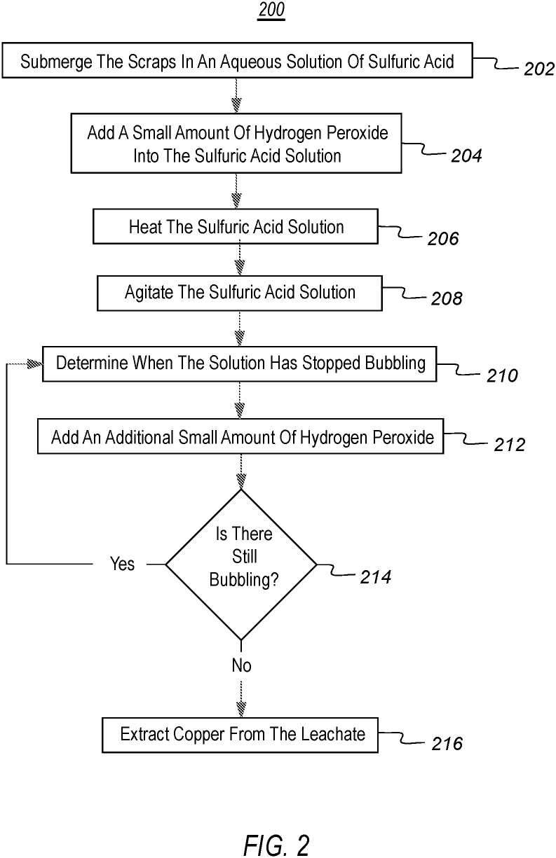

FIG. 2 is a flowchart illustrating a method 200 of recovering scrap copper from scrap sources that include copper. The scrap copper can be recovered from a variety of sources. For example, the copper can be recovered from silicon solar cells, silicon solar panels, electronic wastes, etc. The copper is recovered in a metallic form and at a high purity level. The method 200 is part of a process that is circular, so that the reagents are regenerated.

FIG. 2 also shows that the method 200 can include submerging 202 the scraps in an aqueous solution of sulfuric acid. Submerging 202 for many scrap materials will occur naturally as the scraps will often be denser than the sulfuric acid because of the presence of copper and other metals. The scrap sources can be added to the sulfuric acid or vice versa, whichever process is less likely to cause splashing or other hazards to individuals associated with the process. Sulfuric acid is a solution of hydrogen sulfate (H₂SO₄) in water and is very corrosive. The concentration of sulfuric acid can be between 0.1 wt% and 20 wt%. Although the sulfuric acid is corrosive, there should be no observable reaction with copper at this time. This is because the dissolution of copper is very slow in sulfuric acid.

FIG. 2 further shows that the method 200 can include adding 204 a small amount of hydrogen peroxide (H₂O₂) into the sulfuric acid solution. After adding 204 the hydrogen peroxide, the solution will then begin to bubble. If a large amount of H₂O₂ is added, the solution will bubble violently, splashing hazardous chemicals; thus, it must be added slowly. Therefore, the term “small amount” means approximately 1-10 mL of 30 wt% H₂O₂ per 1 liter of the sulfuric acid solution. The H₂O₂ catalyzes the dissolution of Cu and formation of copper sulfate (CuSO₄) with the reaction:

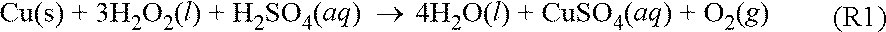

Because of the potential for splashing, covers may be placed over the container into which the scraps were submerged 202. Thus far, the copper is now soluble and the only byproducts are water and oxygen, neither of which are hazardous.

FIG. 2 also shows that the method 200 can include heating 206 the sulfuric acid solution. One of skill in the art will appreciate that heating 206 may not be necessary but heating 206 increases the rate at which the reaction proceeds. That is, heating 206 the sulfuric acid solution makes the reaction proceed faster than if it was occurring at ambient temperature. However, even without heating 206 the reaction will proceed.

FIG. 2 further shows that the method 200 can include agitating 208 the sulfuric acid solution. The bubbles produced by the reaction with the hydrogen peroxide may be enough agitating 208 in some circumstances. Just as with heating 206, agitation 208 can cause the reaction to proceed faster, but the reaction proceeds without agitation 208. Agitation 208 can include stirring, such as with a magnetic stir bar. Likewise, agitation 208 can include shaking (in a closed container) or any other method that causes the solution to mix.

FIG. 2 additionally shows that the method 200 can include determining 210 when the solution has stopped bubbling. The determination can be made manually or through some other detection method. For example, the determination can be made by measuring the release of oxygen. E.g., the outgassing of oxygen can be measured by the increase in oxygen content right above the sulfuric acid solution; therefore, when the oxygen content comes down to a normal level all outgassing has ceased.

FIG. 2 also shows that the method includes adding 212 an additional small amount of hydrogen peroxide. Adding 212 an additional small amount of hydrogen peroxide allows the reaction and formation of copper sulfate to continue to completion. That is, because of how vigorous the reaction is it needs to proceed in small steps. This avoids creating a mess or splashing corrosive chemicals.

FIG. 2 further shows that the method includes determining 214 whether there is still bubbling (i.e., the reaction is continuing). For example, if bubbling can be observed, then the reaction is continuing and if no bubbling is observed then the reaction has ended. Likewise, if oxygen is being produced then the reaction is continuing and if oxygen is not being produced then the reaction has ended. If the reaction continues, then the method returns to step 210.

FIG. 2 additionally shows that the method includes extracting 216 copper from the leachate. A leachate is any liquid that includes any extracted materials from the scrap source which has come into contact with the leaching solution. I.e., the leachate is a liquid material with the copper sulfate present. The leachate can have the non-extracted materials (i.e., the remains of the scrap source minus the now reacted copper) removed prior to extraction 216. For example, the leachate can be poured or otherwise transferred to another container while the non-extracted materials remain in the original container.

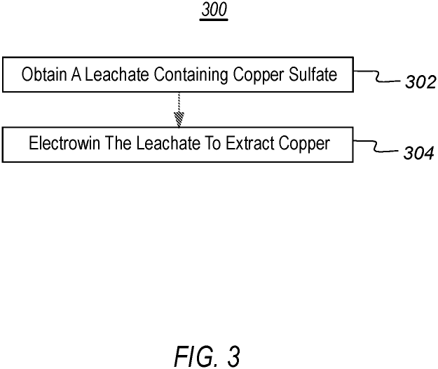

FIG. 3 illustrates a method 300 of extracting copper from a leachate. The method 300 results in metallic copper in a relatively pure form. I.e., the copper metal has very few or no other metals present in the copper. The copper then is not chemically any different than copper from any other production methods and can be used as desired.

FIG. 3 shows that the method 300 can include obtaining 302 a leachate containing copper sulfate. The leachate can be obtained 302 from any desired source. For example, the leachate can be obtained 302 using the method 200 of FIG. 2. Alternatively, the leachate can be obtained using some other method.

FIG. 3 also shows that the method 300 can include electrowinning 304 the leachate to extract copper. Electrowinning 304 extracts metals from solutions containing these metals. In electrowinning 304, a current is passed from an anode through the leachate so that the copper is extracted as it is deposited in an electroplating process onto the cathode. A reference electrode may also be present in some instances. By applying an appropriate voltage on the cathode with respect to the reference electrode, pure copper will deposit on the cathode. During the electrowinning 304 process, sulfuric acid is regenerated in the solution, as described below. The sulfuric acid can be reused for copper recovery in the method 200 of FIG. 2.

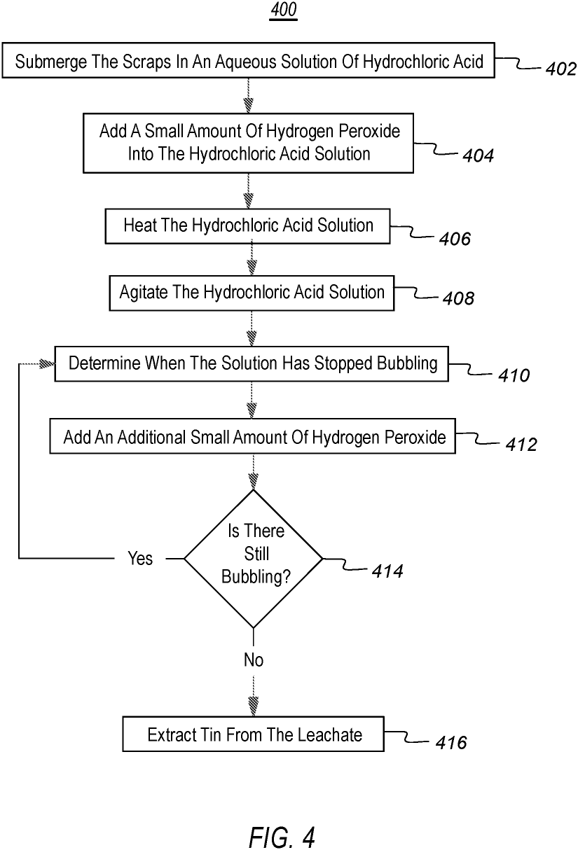

FIG. 4 is a flowchart illustrating a method 400 of recovering scrap tin from scrap sources that include tin. The scrap tin can be recovered from a variety of sources. For example, the tin can be recovered from silicon solar cells, silicon solar panels, electronic wastes, etc. The tin is recovered in a metallic form and at a high purity level. The method 400 is part of a process that is circular, so that the reagents are regenerated. The process can be completed after other metals are recovered from the scrap sources (for example, the method 200 can be performed after copper has been leached as in method 200 of FIG. 2).

FIG. 4 also shows that the method 400 can include submerging 402 the scraps in an aqueous solution of hydrochloric acid. Submerging 402 for many scrap materials will occur naturally as the scraps will often be denser than the hydrochloric acid because of the presence of tin and other metals. The scrap sources can be added to the hydrochloric acid or vice versa, whichever process is less likely to cause splashing or other hazards to individuals associated with the process. Hydrochloric acid is a solution of hydrogen chloride (HCl) in water and is very corrosive. The concentration of hydrochloric acid can be between 0.1 wt% and 20 wt%. Although the hydrochloric acid is corrosive, there should be no observable reaction with tin at this time. This is because the dissolution of tin is very slow in hydrochloric acid.

FIG. 4 further shows that the method 400 can include adding 404 a small amount of hydrogen peroxide (H₂O₂) into the hydrochloric acid solution. After adding 404 the hydrogen peroxide, the solution will then begin to bubble. If a large amount of H₂O₂ is added, the solution will bubble violently, splashing hazardous chemicals; thus, it must be added slowly. Therefore, the term “small amount” means approximately 1-10 mL of 30 wt% H₂O₂ per 1 liter of the hydrochloric acid solution. The H₂O₂ catalyzes the dissolution of Sn and formation of tin chloride (SnCl₂) with the reaction:

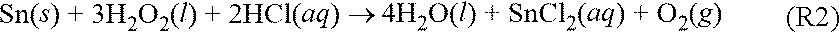

Because of the potential for splashing, covers may be placed over the container into which the scraps were submerged 402. Thus far, the tin is now soluble and the only byproducts are water and oxygen, neither of which are hazardous.

FIG. 4 also shows that the method 400 can include heating 406 the hydrochloric acid solution. One of skill in the art will appreciate that heating 406 may not be necessary but heating 406 increases the rate at which the reaction proceeds. That is, heating 406 the hydrochloric acid solution makes the reaction proceed faster than if it was occurring at ambient temperature. However, even without heating 406 the reaction will proceed.

FIG. 4 further shows that the method 400 can include agitating 408 the hydrochloric acid solution. The bubbles produced by the reaction with the hydrogen peroxide may be enough agitating 208 in some circumstances. Just as with heating 406, agitation 408 can cause the reaction to proceed faster, but the reaction proceeds without agitation 408. Agitation 408 can include stirring, such as with a magnetic stir bar. Likewise, agitation 408 can include shaking (in a closed container) or any other method that causes the solution to mix.

FIG. 4 additionally shows that the method 400 can include determining 410 when the solution has stopped bubbling. The determination can be made manually or through some other detection method. For example, the determination can be made by measuring the release of oxygen. E.g., the outgassing of oxygen can be measured by the increase in oxygen content right above the hydrochloric acid solution; therefore, when the oxygen content comes down to a normal level all outgassing has ceased.

FIG. 4 also shows that the method includes adding 412 an additional small amount of hydrogen peroxide. Adding 412 an additional small amount of hydrogen peroxide allows the reaction and formation of tin chloride to continue to completion. That is, because of how vigorous the reaction is it needs to proceed in small steps. This avoids creating a mess or splashing corrosive chemicals.

FIG. 4 further shows that the method includes determining 414 whether there is still bubbling (i.e., the reaction is continuing). For example, if bubbling can be observed, then the reaction is continuing and if no bubbling is observed then the reaction has ended. Likewise, if oxygen is being produced then the reaction is continuing and if oxygen is not being produced then the reaction has ended. If the reaction continues, then the method returns to step 410.

FIG. 4 additionally shows that the method includes extracting 416 tin from the leachate. A leachate is any liquid that includes any extracted materials from the scrap source which has come into contact with the leaching solution. I.e., the leachate is a liquid material with the tin chloride present. The leachate can have the non-extracted materials (i.e., the remains of the scrap source minus the now reacted tin) removed prior to extraction 416. For example, the leachate can be poured or otherwise transferred to another container while the non-extracted materials remain in the original container.

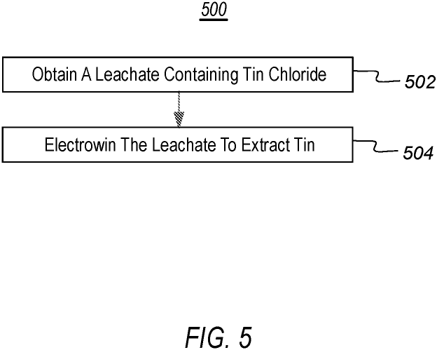

FIG. 5 illustrates a method 500 of extracting tin from a leachate. The method 500 results in metallic tin in a relatively pure form. I.e., the tin metal has very few or no other metals present in the tin. The tin then is not chemically any different than tin from any other production method and can be used as desired.

FIG. 5 shows that the method 500 can include obtaining 502 a leachate containing tin chloride. The leachate can be obtained 502 from any desired source. For example, the leachate can be obtained 502 using the method 400 of FIG. 4. Alternatively, the leachate can be obtained using some other method.

FIG. 5 also shows that the method 500 can include electrowinning 504 the leachate to extract tin. Electrowinning 504 extracts metals from solutions containing these metals. In electrowinning 504, a current is passed from an anode through the leachate so that the tin is extracted as it is deposited in an electroplating process onto the cathode. A reference electrode may also be present in some instances. By applying an appropriate voltage on the cathode with respect to the reference electrode, pure tin will deposit on the cathode. During the electrowinning 504 process, hydrochloric acid is regenerated in the solution, as described below. The hydrochloric acid can be reused for tin recovery in the method 400 of FIG. 4.

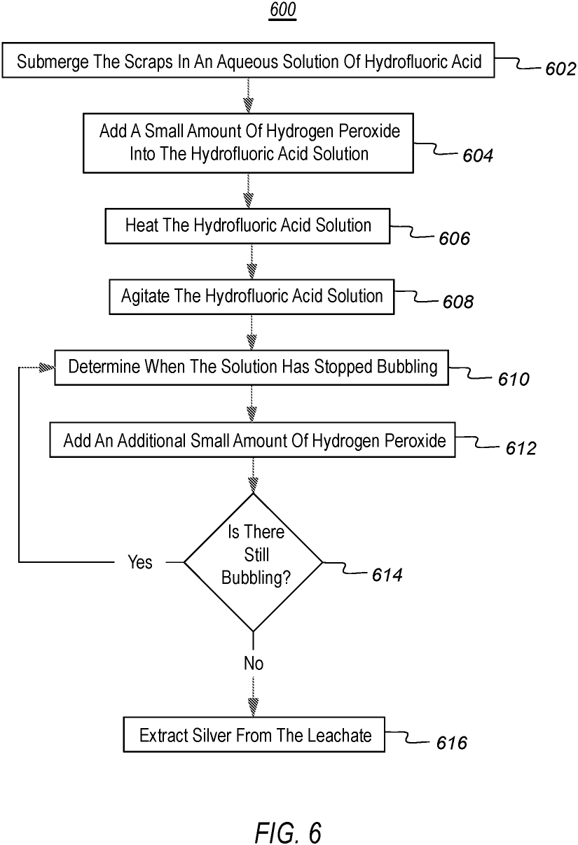

FIG. 6 is a flowchart illustrating a method 600 of recovering scrap silver from scrap sources that include silver. The scrap silver can be recovered from a variety of sources. For example, the silver can be recovered from silicon solar cells, silicon solar panels, electronic wastes, etc. The silver is recovered in a metallic form and at a high purity level. The method 600 is part of a process that is circular, so that the reagents are regenerated. The process can be completed after other metals are recovered from the scrap sources (for example, the method 400 can be performed after copper has been leached as in method 200 of FIG. 2 and tin has been leached as in method 400 of FIG. 4)

FIG. 6 also shows that the method 600 can include submerging 602 the scraps in an aqueous solution of hydrofluoric acid. Submerging 602 for many scrap materials will occur naturally as the scraps will often be denser than the hydrofluoric acid because of the presence of silver and other metals. The scrap sources can be added to the hydrofluoric acid or vice versa, whichever process is less likely to cause splashing or other hazards to individuals associated with the process. Hydrofluoric acid is a solution of hydrogen fluoride (HF) in water and is very corrosive. The concentration of hydrofluoric acid can be between 0.1 wt% and 20 wt%. Although the hydrofluoric acid is corrosive, there should be no observable reaction with silver at this time. This is because the dissolution of silver is very slow in hydrofluoric acid.

FIG. 6 further shows that the method 600 can include adding 604 a small amount of hydrogen peroxide (H₂O₂) into the hydrofluoric acid solution. After adding 604 the hydrogen peroxide, the solution will then begin to bubble. If a large amount of H₂O₂ is added, the solution will bubble violently, splashing hazardous chemicals; thus, it must be added slowly. Therefore, the term “small amount” means approximately 1-10 mL of 30 wt% H₂O₂ per 1 liter of the hydrofluoric acid solution. The H₂O₂ catalyzes the dissolution of Ag and formation of silver fluoride (AgF) with the reaction:

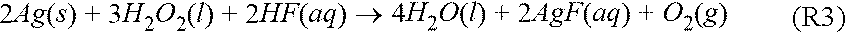

Because of the potential for splashing, covers may be placed over the container into which the scraps were submerged 602. Thus far, the silver is now soluble and the only byproducts are water and oxygen, neither of which are hazardous. As used in the specification and the claims, the term approximately shall mean that the value is within 10% of the stated value, unless otherwise specified.

FIG. 6 also shows that the method 600 can include heating 606 the hydrofluoric acid solution. One of skill in the art will appreciate that heating 606 may not be necessary but heating 606 increases the rate at which the reaction proceeds. That is, heating 606 the hydrofluoric acid solution makes the reaction proceed faster than if it was occurring at ambient temperature. However, even without heating 606 the reaction will proceed.

FIG. 6 further shows that the method 600 can include agitating 608 the hydrofluoric acid solution. The bubbles produced by the reaction with the hydrogen peroxide may be enough agitating 608 in some circumstances. Just as with heating 606, agitation 608 can cause the reaction to proceed faster, but the reaction proceeds without agitation 608. Agitation 608 can include stirring, such as with a magnetic stir bar. Likewise, agitation 608 can include shaking (in a closed container) or any other method that causes the solution to mix.

FIG. 6 additionally shows that the method 600 can include determining 610 when the solution has stopped bubbling. The determination can be made manually or through some other detection method. For example, the determination can be made by measuring the release of oxygen. E.g., the outgassing of oxygen can be measured by the increase in oxygen content right above the hydrofluoric acid solution; therefore, when the oxygen content comes down to a normal level all outgassing has ceased.

FIG. 6 also shows that the method includes adding 612 an additional small amount of hydrogen peroxide. Adding 612 an additional small amount of hydrogen peroxide allows the reaction and formation of silver fluoride to continue to completion. That is, because of how vigorous the reaction is it needs to proceed in small steps. This avoids creating a mess or splashing corrosive chemicals.

FIG. 6 further shows that the method includes determining 614 there is still bubbling (i.e., whether the reaction is continuing). For example, if bubbling can be observed, then the reaction is continuing and if no bubbling is observed then the reaction has ended. Likewise, if oxygen is being produced then the reaction is continuing and if oxygen is not being produced then the reaction has ended. If the reaction continues, then the method returns to step 610.

FIG. 6 additionally shows that the method includes extracting 616 silver from the leachate. A leachate is any liquid that includes any extracted materials from the scrap source which has come into contact with the leaching solution. I.e., the leachate is a liquid material with the silver fluoride present. The leachate can have the non-extracted materials (i.e., the remains of the scrap source minus the now reacted silver) removed prior to extraction 616. For example, the leachate can be poured or otherwise transferred to another container while the non-extracted materials remain in the original container.

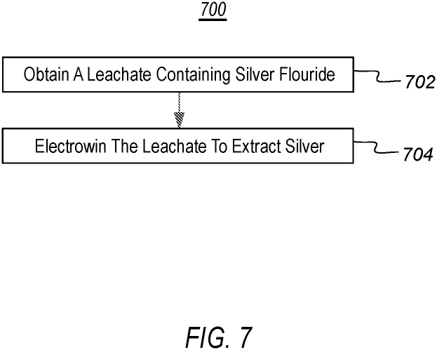

FIG. 7 illustrates a method 700 of extracting silver from a leachate. The method 700 results in metallic silver in a relatively pure form. I.e., the silver metal has very few or no other metals present in the silver. The silver then is not chemically any different than silver from any other production method and can be used as desired.

FIG. 7 shows that the method 700 can include obtaining 702 a leachate containing silver fluoride. The leachate can be obtained 702 from any desired source. For example, the leachate can be obtained 702 using the method 600 of FIG. 6. Alternatively, the leachate can be obtained using some other method.

FIG. 7 also shows that the method 700 can include electrowinning 704 the leachate to extract silver. Electrowinning 704 extracts metals from solutions containing these metals. In electrowinning 704, a current is passed from an anode through the leachate so that the silver is extracted as it is deposited in an electroplating process onto the cathode. A reference electrode may also be present in some instances. By applying an appropriate voltage on the cathode with respect to the reference electrode, pure silver will deposit on the cathode. During the electrowinning 704 process, hydrofluoric acid is regenerated in the solution, as described below. The hydrofluoric acid can be reused for silver recovery in the method 600 of FIG. 6. Better than 96% recovery of high-purity silver has been demonstrated by electrowinning 704.

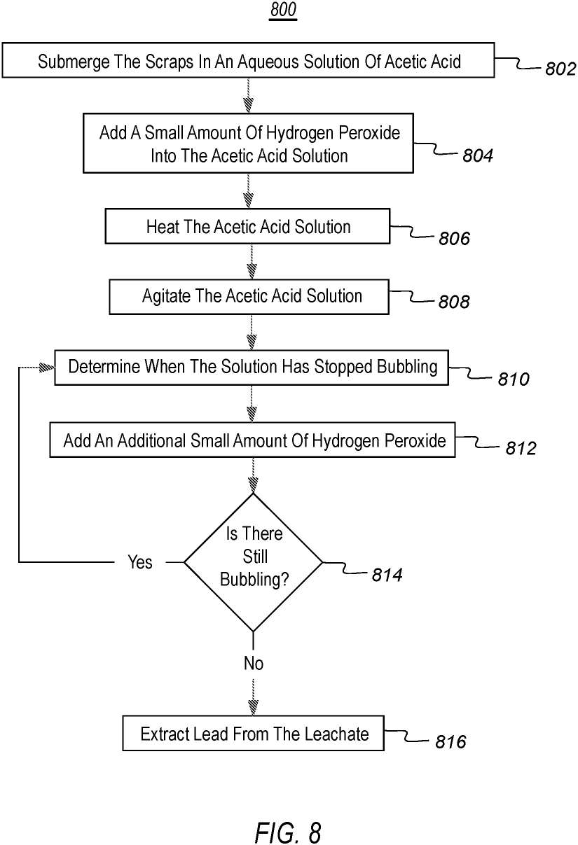

FIG. 8 is a flowchart illustrating a method 800 of recovering scrap lead from scrap sources that include lead. The scrap lead can be recovered from a variety of sources. For example, the lead can be recovered from silicon solar cells, silicon solar panels, electronic wastes, etc. The lead is recovered in a metallic form and at a high purity level. The process can be completed after other metals are recovered from the scrap sources (for example, the method 800 can be performed after silver has been leached and electrowinned as in method 200 of FIG. 2 and method 300 of FIG. 3, copper has been leached and electrowinned as in method 400 of FIG. 4 and method 500 of FIG. 5 and tin has been leached and electrowinned as in method 600 of FIG. 6 and method 700 of FIG. 7).

FIG. 8 also shows that the method 800 can include submerging 802 the scraps in an aqueous solution of acetic acid. Submerging 802 for many scrap materials will occur naturally as the scraps will often be denser than the acetic acid because of the presence of lead and other metals. The scrap sources can be added to the acetic acid or vice versa, whichever process is less likely to cause splashing or other hazards to individuals associated with the process. Acetic acid is a solution of hydrogen acetate (CH₃COOH) in water. The concentration of acetic acid can be between 0.1 wt% and 20 wt%. Although the acetic acid is corrosive, there should be no observable reaction with lead at this time. This is because the dissolution of lead is very slow in acetic acid.

FIG. 8 further shows that the method 800 can include adding 804 a small amount of hydrogen peroxide (H₂O₂) into the acetic acid solution. Hydrogen peroxide is normally used in an aqueous solution. After adding 804 the hydrogen peroxide, the solution will then begin to bubble. If a large amount of H₂O₂ is added, the solution will bubble violently, splashing hazardous chemicals; thus, it must be added slowly. Therefore, the term “small amount” means approximately 1-10 mL of 30 wt% H₂O₂ per 1 liter of the acetic acid solution. The H₂O₂ catalyzes the dissolution of Pb and formation of lead acetate (Pb(CH₃COO)₂) with the reaction:

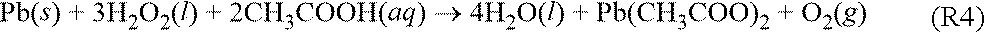

Because of the potential for splashing, covers may be placed over the container into which the scraps were submerged 802. Thus far, the lead is now soluble and the only byproducts are water and oxygen, neither of which are hazardous.

FIG. 8 also shows that the method 800 can include heating 806 the acetic acid solution. One of skill in the art will appreciate that heating 806 may not be necessary but heating 806 increases the rate at which the reaction proceeds. That is, heating 806 the acetic acid solution makes the reaction proceed faster than if it was occurring at ambient temperature. However, even without heating 806 the reaction will proceed.

FIG. 8 further shows that the method 800 can include agitating 808 the acetic acid solution. The bubbles produced by the reaction with the hydrogen peroxide may be enough agitating 208 in some circumstances. Just as with heating 806, agitation 808 can cause the reaction to proceed faster, but the reaction proceeds without agitation 808. Agitation 808 can include stirring, such as with a magnetic stir bar. Likewise, agitation 808 can include shaking (in a closed container) or any other method that causes the solution to mix.

FIG. 8 additionally shows that the method 800 can include determining 810 when the solution has stopped bubbling. The determination can be made manually or through some other detection method. For example, the determination can be made by measuring the release of oxygen. E.g., the outgassing of oxygen can be measured by the increase in oxygen content right above the acetic acid solution; therefore, when the oxygen content comes down to a normal level all outgassing has ceased.

FIG. 8 also shows that the method includes adding 812 an additional small amount of hydrogen peroxide. Adding 812 an additional small amount of hydrogen peroxide allows the reaction and formation of lead acetate to continue to completion. That is, because of how vigorous the reaction is it needs to proceed in small steps. This avoids creating a mess or splashing corrosive chemicals.

FIG. 8 further shows that the method includes determining 814 whether there is still bubbling (i.e., the reaction is continuing). For example, if bubbling can be observed, then the reaction is continuing and if no bubbling is observed then the reaction has ended. Likewise, if oxygen is being produced then the reaction is continuing and if oxygen is not being produced then the reaction has ended. If the reaction continues, then the method returns to step 810.

FIG. 8 additionally shows that the method includes extracting 816 lead from the leachate. A leachate is any liquid that includes any extracted materials from the scrap source which has come into contact with the leaching solution. I.e., the leachate is a liquid material with the lead acetate present. The leachate can have the non-extracted materials (i.e., the remains of the scrap source minus the now reacted lead) removed prior to extraction 816. For example, the leachate can be poured or otherwise transferred to another container while the non-extracted materials remain in the original container.

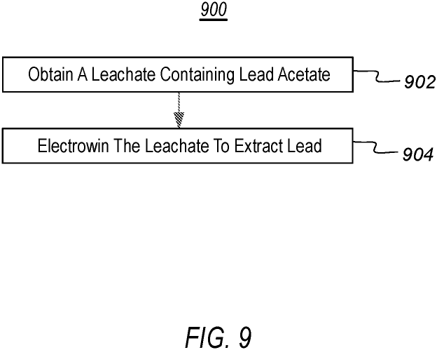

FIG. 9 illustrates a method 900 of extracting lead from a leachate. The method 900 results in metallic lead in a relatively pure form. I.e., the lead metal has very few or no other metals present in the lead. The lead then is not chemically any different than lead from any other production method and can be used as desired.

FIG. 9 shows that the method 900 can include obtaining 902 a leachate containing lead acetate. The leachate can be obtained 902 from any desired source. For example, the leachate can be obtained 902 using the method 800 of FIG. 8. Alternatively, the leachate can be obtained using some other method.

FIG. 9 also shows that the method 900 can include electrowinning 904 the leachate to extract lead. Electrowinning 904 extracts metals from solutions containing these metals. In electrowinning 904, a current is passed from an anode through the leachate so that the lead is extracted as it is deposited in an electroplating process onto the cathode. A reference electrode may also be present in some instances. By applying an appropriate voltage on the cathode with respect to the reference electrode, pure lead will deposit on the cathode. During the electrowinning 904 process, acetic acid is not regenerated in the solution, as described below.

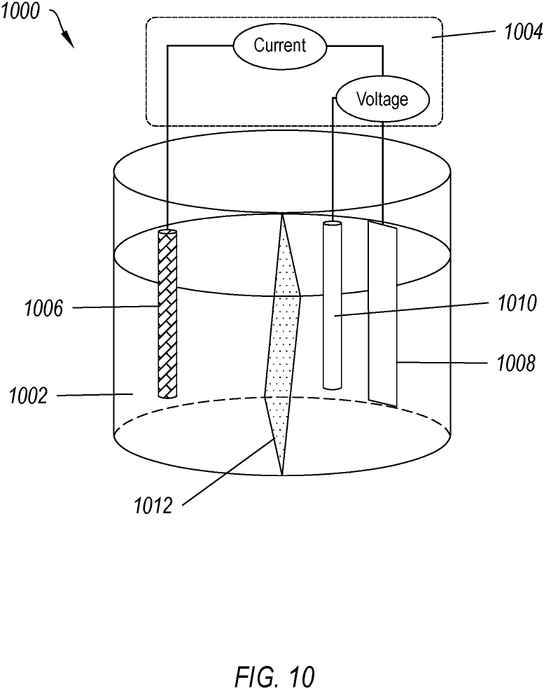

FIG. 10 illustrates an example of an electrowinning system 1000. The electrowinning system 1000 can be used to extract silver, copper, tin, and lead from their respective leachates. In particular, the electrowinning system 1000 can remove pure silver from a leachate that contains silver, such as the leachate produced in the method 100 of FIG. 1. One of skill in the art will appreciate that the electrowinning system 1000 can be used to extract other metals as well.

FIG. 10 shows that the electrowinning system 1000 includes a container 1002. The container 1002 is used to hold an aqueous leachate solution. I.e., a solution that includes dissolved metal ions and may include a reagent to be regenerated (such as hydrofluoric acid, sulfuric acid, or hydrochloric acid). The leachate solution will be subjected to an electric field, as discussed below. The leachate solution can be produced using any of the methods discussed above, but the scrap sources will not be present in the leachate at the time of electrowinning.

FIG. 10 also shows that the electrowinning system 1000 can include a direct current power source 1004. The power source 1004 creates a voltage between two electrodes. I.e., the power sources 1004 creates a voltage to move electrons from one electrode to another (which results in an electric current). The power source 1004 can include an electrical voltage created conventionally by using a direct current power supply or can include a battery or other power source.

If using a three-electrode system, the power source 1004 can include a potentiostat, which is a specialized form of a direct current power supply. A potentiostat is the electronic hardware required to control a three-electrode system. A potentiostat functions by maintaining the voltage of a working electrode (in this case a cathode) at a constant level with respect to a reference electrode by adjusting the current at a counter electrode (in this case an anode).

FIG. 10 further shows that the electrowinning system 1000 can include a counter electrode as the anode 1006. The anode 1006 provides electrons to the power source 1004 (such as a potentiostat) by removing the electrons from one or more elements in the leaching solution or the anode. For example, the anode 1006 can include graphite with a polypropylene mesh sheath, which is electrically conductive. Graphite is stable in aqueous hydrofluoric acid. However, to prevent flakes of graphite from falling into and contaminating the leaching solution, a polypropylene or fluoropolymer mesh sheath is wrapped around the graphite electrode.

FIG. 10 additionally shows that the electrowinning system 1000 can include a working electrode as the cathode 1008. The cathode 1008 can be any metal but is preferentially the metal that is being electrowinned so that the recovered metal is plated onto the same metal serving as the cathode 1008. The cathode receives electrons from the power source 1004 (such as a potentiostat) and provides them to the metal ions in the leachate. That is, metal ions are attracted to the cathode 1008 because of the negative charge of the electrons, which then creates solid metal, in turn removing the charge and allowing more charge to flow into the cathode 1008, repeating the cycle.

FIG. 10 moreover shows that the electrowinning system 1000 includes a reference electrode 1010. The reference electrode 1010 allows a controlled voltage to be maintained by the power source 1004 (such as a potentiostat). The reference electrode 1010 includes any material which remains stable and chemically inactive within the aqueous leachate solution. For example, the reference electrode 1010 can include a silver/silver chloride reference electrode or a metal electrode such as platinum, nickel, or silver.

FIG. 10 also shows that the electrowinning system 1000 can include a chemically inactive sheet 1012. If there is too much metal in the leachate to recover, needles of metal will grow on the cathode 1008 toward the anode 1006, potentially short-circuiting the system by touching the anode 1006. The sheet 1012 is placed between the cathode 1008 and anode 1006 to prevent the electrowinning system 1000 from shorting. The sheet 1012 can include any desired material. For example, the sheet 1012 can include a polypropylene or fluoropolymer sheet.

Experimental results using an anode 1006 of graphite with a polypropylene mesh sheath, a cathode 1008 of silver and a reference electrode 1010 comprising a silver/silver chloride electrode shows a reduction peak at 0.4 V vs. the Ag/AgCl reference electrode 1010. This could be the silver reduction peak: Ag⁺(aq) + e⁻ → Ag(s). In experiments, a constant voltage of 0.3 V vs. the Ag/AgCl reference electrode 1010 was applied to the silver cathode 1008, which resulted in silver deposition on the working electrode.

Selective recovery of pure metals is desirable. Selectivity can be introduced either during metal leaching or during electrowinning, i.e., selective leaching or selective electrowinning. Our detailed leaching experiments reveal the selectivity of different acids on different metals. For example, hydrofluoric acid has an excellent selectivity of silver over lead, and sulfuric acid favors tin over lead. An alternative to selective leaching is selective electrowinning to recover pure metals. Selective electrowinning is based on the different reduction potentials of different metals. Selective electrowinning is disclosed in M. Tao and Wen-Hsi Huang, Recovery of Valuable or Toxic Metals from Silicon Solar Cells, US Pat. No. 10,385,421 (Date issued: Aug. 20, 2019), which is incorporated herein in its entirety. Table 1 lists the standard reduction potentials for four metals involved in silicon solar cells. If we fail to selectively leach them one by one in different acids, we can perform selective electrowinning to extract them one by one from the leachate.

TABLE 1

Standard reduction potentials for metals in silicon solar cells.

| Half reaction | Eₒ (V) |
|---|---|
| Ag⁺ + e⁻ ⇌ Ag(s) | 0.7996 |
| Cu2⁺ + 2e⁻ ⇌ Cu(s) | 0.3419 |
| Pb2⁺ + 2e⁻ ⇌ Pb(s) | -0.1262 |
| Sn2⁺ + 2e⁻ ⇌ Sn(s) | -0.1375 |

During electrowinning the conditions are chose to enforce water oxidation on the anode, which regenerates the leaching acid:

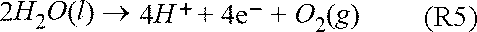

This reaction requires an inert anode (such as a graphite anode) and a more stable anion in the leachate than the water molecule. Table 2 lists the standard reduction potentials for various anions in inorganic acids. Fluorine, chlorine, and sulfate ions all have more positive reduction potentials than reaction R5. This means reaction R5 is the anode reaction in these systems and the leaching acids can be regenerated during electrowinning with an inert anode. The regenerated acids will be then reused for metal leaching, minimizing the chemical waste from recycling.

TABLE 2

Standard reduction potentials for anions in inorganic acids as compared to water oxidation.

| Half reaction | Eₒ (V) |
|---|---|
| F₂(g) + 2e⁻ ⇌ 2F⁻ | 2.87 |
| S₂O₈²⁻ + 2e⁻ ⇌ 2SO₄²⁻ | 2.01 |
| Cl₂(g) + 2e⁻ ⇌ 2Cl⁻ | 1.36 |
| O₂(g) + 4H⁺ + 4e- ⇌ 2H₂O | 1.229 |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for recovering metals from scrap sources, the method comprising:
obtaining scrap sources that include the metal to be recovered;
removing the metal from the scrap sources, wherein removing the metal from the scrap sources includes:
adding a reagent to the scrap sources, the reagent configured to leach the metal from the scrap sources creating a leachate;
extracting the metal from the leachate; and
regenerating the reagent.

2. The method of claim 1, wherein the scrap sources include at least one of:
silver;
copper;
tin; or
lead.

3. A method for recovering metals from scrap sources, the method comprising:
obtaining scrap sources that include:
copper;
tin;
silver; and
lead;
removing the copper from the scrap sources, wherein removing the copper from the scrap sources includes:
adding a first reagent to the scrap sources, the first reagent configured to leach copper from the scrap sources creating a first leachate;
removing the first leachate from the scrap sources;
extracting the copper from the first leachate; and
regenerating the first reagent;
removing the tin from the scrap sources, wherein removing the tin from the scrap sources includes:
adding a second reagent to the scrap sources, the second reagent configured to leach tin from the scrap sources creating a second leachate;
removing the second leachate from the scrap sources;
extracting the tin from the second leachate; and
regenerating the second reagent;
removing the silver from the scrap sources, wherein removing the silver from the scrap sources includes:
adding a third reagent to the scrap sources, the third reagent configured to leach silver from the scrap sources creating a third leachate;
removing the third leachate from the scrap sources;
extracting the silver from the third leachate; and
regenerating the third reagent; and
removing the lead from the scrap sources, wherein removing the lead from the scrap sources includes:
adding a fourth reagent to the scrap sources, the fourth reagent configured to leach lead from the scrap sources creating a fourth leachate; and
extracting the lead from the fourth leachate.

4. The method of claim 3, wherein the scrap sources include at least one of:
silicon solar cells;
silicon solar panels; or
electronic wastes.

5. The method of claim 3, wherein extracting the copper from the first leachate includes electrowinning.

6. The method of claim 5, wherein electrowinning regenerates the first reagent.

7. The method of claim 3, wherein extracting the tin from the second leachate includes electrowinning.

8. The method of claim 7, wherein electrowinning regenerates the second reagent.

9. The method of claim 3, wherein extracting the silver from the third leachate includes electrowinning.

10. The method of claim 9, wherein electrowinning regenerates the third reagent.

11. The method of claim 3, wherein extracting the lead from the fourth leachate includes electrowinning.

12. A method for recovering metals from scrap sources, the method comprising:
obtaining scrap sources that include:
copper;
tin;
silver; and
lead;
removing the copper from the scrap sources, wherein removing the copper from the scrap sources includes:
submerging the scrap sources in an aqueous solution of sulfuric acid;
adding hydrogen peroxide to the aqueous solution of sulfuric acid to create a copper leachate;
removing the copper leachate from the scrap sources;
extracting the copper from the copper leachate using electrowinning, wherein electrowinning:
plates the copper on a first cathode; and
regenerates the sulfuric acid; and
removing the first cathode including the plated copper from the sulfuric acid solution;
removing the tin from the scrap sources, wherein removing the tin from the scrap sources includes:
submerging the scrap sources in an aqueous solution of hydrochloric acid;
adding hydrogen peroxide to the aqueous solution of hydrochloric acid to create a tin leachate;
removing the tin leachate from the scrap sources;
extracting the tin from the tin leachate using electrowinning, wherein electrowinning:
plates the tin on a second cathode; and
regenerates the hydrochloric acid; and
removing the second cathode including the plated tin from the hydrochloric acid solution;
removing the silver from the scrap sources, wherein removing the silver from the scrap sources includes:
submerging the scrap sources in an aqueous solution of hydrofluoric acid;
adding hydrogen peroxide to the aqueous solution of hydrofluoric acid to create a silver leachate;
removing the silver leachate from the scrap sources;
extracting the silver from the silver leachate using electrowinning, wherein electrowinning:
plates the silver on a third cathode; and
regenerates the hydrofluoric acid; and
removing the third cathode including the plated silver from the hydrofluoric acid solution;
removing the lead from the scrap sources, wherein removing the lead from the scrap sources includes:
submerging the scrap sources in an aqueous solution of acetic acid;
adding hydrogen peroxide to the aqueous solution of acetic acid to create a lead leachate;
removing the lead leachate from the scrap sources;
extracting the lead from the lead leachate using electrowinning, wherein electrowinning plates the lead on a fourth cathode; and
removing the fourth cathode including the plated lead from the acetic acid solution.

13. The method of claim 12 wherein:
the addition of hydrogen peroxide to the hydrofluoric acid:
catalyzes the dissolution of silver; and
produces oxygen bubbling as a byproduct of the dissolution of silver.

14. The method of claim 13 further comprising:
determining when the combination of hydrofluoric acid and hydrogen peroxide has stopped bubbling;
when the combination of hydrofluoric acid and hydrogen peroxide has stopped bubbling:
adding additional hydrogen peroxide;
determining whether the reaction is continuing; and
if the reaction is continuing, returning to the step of determining when the solution has stopped bubbling.

15. The method of claim 14, wherein determining when the solution has stopped bubbling includes measuring the outgassing of oxygen.

16. The method of claim 14, wherein determining whether the reaction is continuing includes measuring the outgassing of oxygen.

17. The method of claim 12, wherein the electrowinning method includes:
a container;
a power source including a potentiostat; and
an anode.

18. The method of claim 17, wherein the anode includes graphite with a polypropylene mesh sheath.

19. The method of claim 17, wherein the electrowinning method additionally includes:
a reference electrode.

20. The method of claim 19, wherein the reference electrode includes at least one of:
a silver/silver chloride electrode;
a platinum electrode; or
a nickel electrode.
